(19) United States
(12) Patent Application Publication
(10) Pub. No.: US 2012/0143778 A1
(43) Pub. Date: Jun. 7, 2012

(54) Method and System for Representing Laws and Rules

(75) Inventors: Sharada Sundaram, Mountain View, CA (US); Peifung E. Lam, Mountain View, CA (US); John C. Mitchell, Stanford, CA (US)

(73) Assignee: The Board of Trustees of the Leland Stanford, Junior, University, Palo Alto, CA (US)

(21) Appl. No.: 13/219,638

(22) Filed: Aug. 27, 2011

Related U.S. Application Data
(60) Provisional application No. 61/377,612, filed on Aug. 27, 2010.

(51) Int. Cl. G06Q 10/00

(52) U.S. Cl. 705/317

(57) ABSTRACT

The complexity of regulations in healthcare, financial services, and other industries makes it difficult for enterprises to design and deploy effective compliance systems. The present invention supports compliance by using formalized portions of applicable laws to regulate business processes that use information systems. An embodiment of the present invention uses a stratified fragment of Prolog with limited use of negation to formalize a portion of the US Health Insurance Portability and Accountability Act (HIPAA). An embodiment of the invention provides for deployment in a prototypical hospital that implements a Web portal messaging system.

### FIELD OF THE INVENTION

The present invention generally relates to computerized methods and systems for assuring compliance with applicable laws and rules.

### BACKGROUND OF THE INVENTION

In regulated sectors such as healthcare, finance, and accounting, laws such as the U.S. Health Insurance Portability and Accountability Act (HIPAA), the Gramm-Leach-Bliley Act, the Sarbanes-Oxley Act, and related European laws have been enacted over the past decade to establish new or enhanced standards. The length of these laws, the opacity of the legal language, and the complexity of these acts make it difficult for practitioners to determine whether they are in compliance. This complexity becomes even more significant if computer programmers and information technology professionals wish to build and configure automated systems to help business professionals comply with applicable laws.

There is a need in the art for automated systems for assuring compliance with laws and rules. There is a further need to for an automated compliance checking system that is itself amenable to verifying that its programming is correct an in alignment with the applicable laws and rules.

### SUMMARY OF THE INVENTION

The present invention makes use of a fragment of stratified Datalog with limited use of negation, and implements a specific format for compositionally representing clauses of a law as Datalog rules. An embodiment of the invention provides a framework to formalize the part of the US Health Insurance Portability and Accountability Act (HIPAA) that regulates information sharing in a healthcare provider environment. This executable formalization of legal regulation was tested by implementing a prototype web-based message system and compliance checker based on the Vanderbilt Medical Center MyHealth web portal.

The formalization of the present invention was also used to examine conflicts in the HIPAA regulation. By querying the logic program to return all the possible agents who could gain access to patient information, some anomalies were found regarding lack of regulation of government employees who are granted access to medical data, for example. While the present disclosure focuses on the formalization of HIPAA, the teachings of the present invention can generally be applied to a broad class of privacy regulations. For example, it may be applied to those consistent with Nissenbaum's theory of Contextual Integrity.

Those of skill in the art will appreciate that the teaching of the present invention can be applied to laws, rules, or regulations with similar structures to those of HIPAA as used as an example in the present disclosure. Indeed, the teachings of the present invention can be applied to other aspects of HIPAA not discussed here.

The present invention may also be enhanced by generating meaningful annotated audit logs, as by logging messages with semantic information about each action and compliance issues associated with it. In addition to automating compliance tasks, a formal presentation of HIPAA (or other regulations) could also be useful in training medical personnel about the consequences and non-consequences of the law. These and other extensions of the present invention will be obvious to those of ordinary skill in the art without deviating from the teachings described above and claimed below.

### BRIEF DESCRIPTION OF THE DRAWINGS

FIG. 1 is a block diagram of a computer system on which embodiments of the present invention can be implemented.

FIG. 2 is a block diagram of a distributed computing system on which embodiments of the present invention can be implemented.

FIG. 3 is a flow diagram of a method according to an embodiment of the present invention.

FIG. 4 is a representation of a graphical user interface according to an embodiment of the present invention.

FIG. 5 is a representation of a graphical user interface according to an embodiment of the present invention.

FIG. 6 is a representation of a graphical user interface according to an embodiment of the present invention.

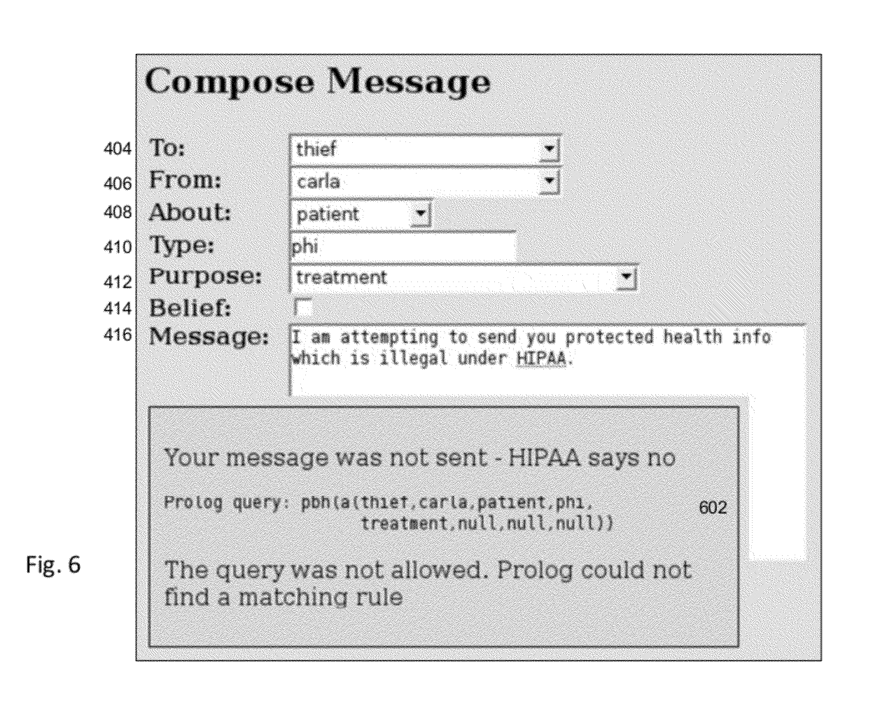

### DETAILED DESCRIPTION

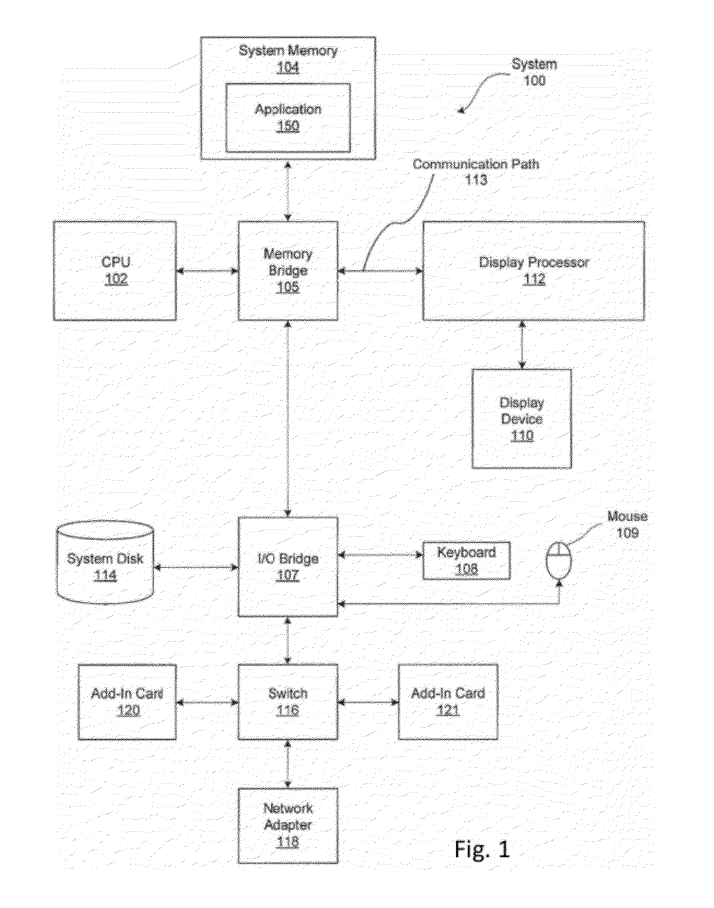

Among other things, the present invention relates to methods, techniques, and algorithms that are intended to be implemented in a digital computer system. By way of overview that is not intended to be limiting, digital computer system 100 as shown in FIG. 1 will be described. Such a digital computer or embedded device is well-known in the art and may include variations of the below-described system.

FIG. 1 is a block diagram of a system 100 configured to implement one or more aspects of the present invention. System 100 may be a computer workstation, personal computer, or any other device suitable for practicing one or more embodiments of the present invention. As shown, system 100 includes one or more processing units, such as central processing unit (CPU) 102, and a system memory 104 communicating via a bus path that may include a memory bridge 105. CPU 102 includes one or more processing cores, and, in operation; CPU 102 is the master processor of system 100, controlling and coordinating operations of other system components. System memory 104 stores software applications and data for use by CPU 102. CPU 102 runs software applications and optionally an operating system. Memory bridge 105, which may be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices such as keyboard 108 or mouse 109 and forwards the input to CPU 102 via memory bridge 105. In alternative embodiments, I/O bridge 107 may also be connected to other input devices such as a joystick, digitizer tablets, touch pads, touch screens, still or video cameras, motion sensors, and/or microphones (not shown).

One or more display processors, such as display processor 112, are coupled to memory bridge 105 via a bus or other communication path 113 (e.g., a PCI Express, Accelerated Graphics Port, or HyperTransport link); in one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104. Display processor 112 periodically delivers pixels to a display device 110 that may be any conventional CRT or LED monitor. Display processor 112 can provide display device 110 with an analog or digital signal.

A system disk 114 is also connected to I/O bridge 107 and may be configured to store content and applications and data for use by CPU 102 and display processor

112. System disk 114 provides non-volatile storage for applications and data and may include fixed or removable hard disk drives, flash memory devices, and CD-ROM, DVD ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 incorporates circuitry optimized for general purpose processing. In yet another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments of the present invention, instructions and/or data representing a scene are provided to a render farm or a set of server computers, each similar to system 100, via network adapter 118 or system disk 114. The render farm generates one or more rendered images of the scene using the provided instructions and/or data. These rendered images may be stored on computer-readable media in a digital format and optionally returned to system 100 for display.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or a graphics memory within display processor 112. In an embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

In one embodiment, application 150 is stored in system memory 104. Application 150 may be any application configured to display a graphical user interface (GUI) on display device 110. Application 150 may be configured to generate and modify documents based on input received from a user. For example, application 150 may be a word processing application or an image editing program.

It will be appreciated that the system shown herein is illustrative and that variations and modifications are possible. The connection topology, including the number and arrangement of bridges, may be modified as desired. For instance, in some embodiments, system memory 104 may be connected to CPU 102 directly rather than through a bridge, and other devices may communicate with system memory 104 via memory bridge 105 and CPU 102. In other alternative topologies display processor 112 may be connected to I/O bridge 107 or directly to CPU 102, rather than to memory bridge 105. In still other embodiments, I/O bridge 107 and memory bridge 105 may be integrated in a single chip. In addition, the particular components shown herein are optional. For instance, any number of add-in cards or peripheral devices might be supported. In some embodiments, switch 116 is eliminated, and network adapter 118 and add-in cards 120, 121 connect directly to I/O bridge 107.

An embodiment of the present invention provides a method for representing and processing laws, rules, regulations, and policies in a messaging system. Among other things, the present invention provides a method for representing and processing privacy laws and compliance to such laws is provided.

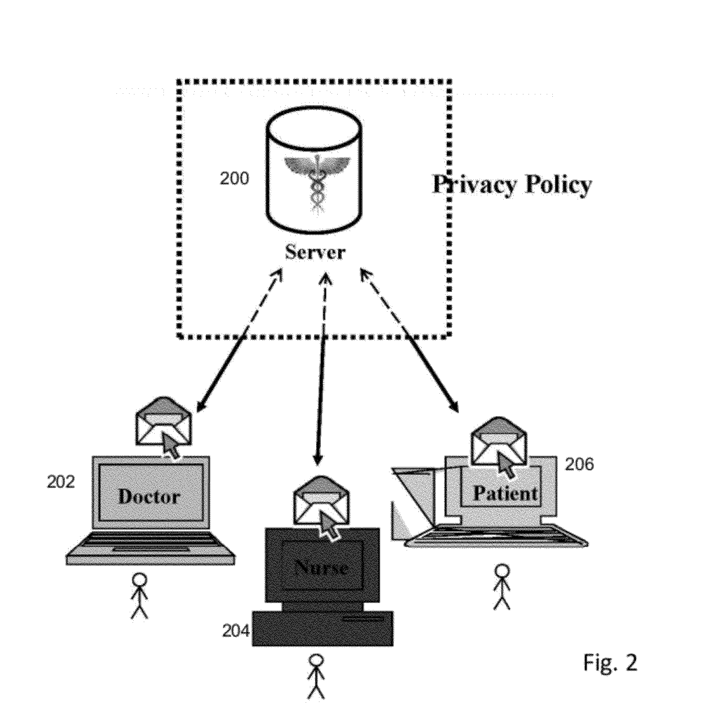

The U.S. Health Insurance Portability and Accountability Act (HIPAA) title II was enacted in 1996. In an embodiment of the present invention, HIPAA regulations in a messaging system are described. As shown in FIG. 2, health providers desire to pass messages among doctors 202, nurses 204, and patients 206, for example, through a centralized message server 200. To address certain privacy concerns, however, such messages must be closely controlled so as to assure compliance with such laws as HIPAA. Towards meeting this need, the present invention provides a novel approach for implementing a privacy policy on server 100 so as to reasonably assure compliance.

The HIPAA regulation is complex for non-experts to follow for a number of reasons. For example, the law generally allows protected information to be shared between appropriate entities for the purpose of treatment. But clause 164.508.a.2, for example, apparently contradicts this by stating that if the protected information is a psychotherapy note then a covered entity, e.g., a health plan, a health care provider or a clearinghouse, must obtain an authorization before disclosure. Thus, simple reasoning based on actions allowed by one portion of the law, without accounting for prohibitions in other portions of the law, may give erroneous results.

The present invention provides a formalization of applicable parts of the HIPAA regulation in a form that can be used in a messaging system. Through Web access to a centralized system, such a messaging system allows patients and medical professionals to exchange messages and, as necessary, request and view information such as prescriptions or lab test results.

The present invention can also be used in such systems to respond to requests from other hospitals and clinics, law enforcement, insurers, and other organizations. A compliance module that decides, as messages are composed or entered into the system, whether a message complies with HIPAA is disclosed. The present invention can further be extended and modified as HIPAA and other applicable laws are modified or supplemented.

Starting with a view of privacy policy, business processes, and compliance, an embodiment of the present invention implements a stratified fragment of the logic programming language Prolog with limited use of negation.

In addition to representing HIPAA precisely enough to determine whether any particular action within the scope of the messaging system would comply with the applicable law, the present invention provides a formalization that is verifiable by lawyers, medical, and computer professionals alike. For this reason, the present invention formalizes the law so that the Prolog presentation can be read and understood section by section, with the meaning of the entire presentation determined in a systematic way from the meaning of its parts. In addition to supporting outside review and audit, this approach also allows HIPAA formalization to be combined with additional policies adopted by regulated enterprises.

An embodiment of the present invention focuses on a specific privacy law, identification of a specific fragment of stratified Datalog that appears appropriate to the task, and a reliance on a general theory of privacy previously articulated for a more expressive but less commonly implemented logical framework.

The present invention identifies a specific fragment of stratified Datalog with one alternation of negation which suits the present invention and supports a certain degree of policy compositionality. The present invention uses this framework to formalize the part of the HIPAA law that regulates information sharing in a healthcare provider environment. The structure of logic programming with predicates, query, and facts correspond to the legal clauses, actions being performed, and relations like roles defined in the law. As a subset of logic programming, the methods of the present invention facilitate the addition of cross references as present in the law.

The present invention also implements a prototype compliance checker and message system as a web-based system. This embodiment is used to decide if a message that a practitioner is about to send is in compliance with the HIPAA regulation. The present invention is also used to examine conflicts in the HIPAA regulation.

While the present invention focuses on the formalization of HIPAA, those of skill in the art will appreciate that the teachings as presented herein apply generally to a broad class of privacy regulations. More generally, the present invention can be applied to other laws, rules, and regulations with an appropriate structure that are used to control actions.

In the present disclosure, the key features and structure of the HIPAA policy and an information sharing model of the present invention will be introduced and summarized. Next, the modified computer language as used in the present invention to model the HIPAA policy and the rule composition approach will be described.

HIPAA both explicitly permits certain transfers of personal health information and prohibits some disclosures. For example, HIPAA provides federal protections for personal health information held by covered entities and gives patients an array of rights with respect to that information. Also, HIPAA regulates the use and disclosure of personal health information.

In HIPAA terminology, a covered entity is a health plan, a health care clearinghouse, or a health care provider that transmits health information in electronic form. Protected health information is individually identifiable health information that is transmitted or maintained in electronic or other media.

For purposes of describing features and aspects of the present invention, the present disclosure focuses section 164 of HIPAA, which regulates the security and privacy issues in the health care industry. One of skill in the art, however, will appreciate that the teachings provided herein are not so limited and can actually be extended to many other applications with appropriately structured laws, rules, or regulations, for example.

An embodiment of the present invention covers general provisions, security standards for the protection of electronic health information, and privacy of individually identifiable health information. The present disclosure specifically addresses subpart 164.502, which covers the general rules for uses and disclosures of protected health information. Of the many subparts it references, the present disclosure considers subpart 164.506, which covers uses and disclosures to carry out treatment, payment, or health care operations, and subpart 164.508, which covers uses and disclosures requiring an authorization.

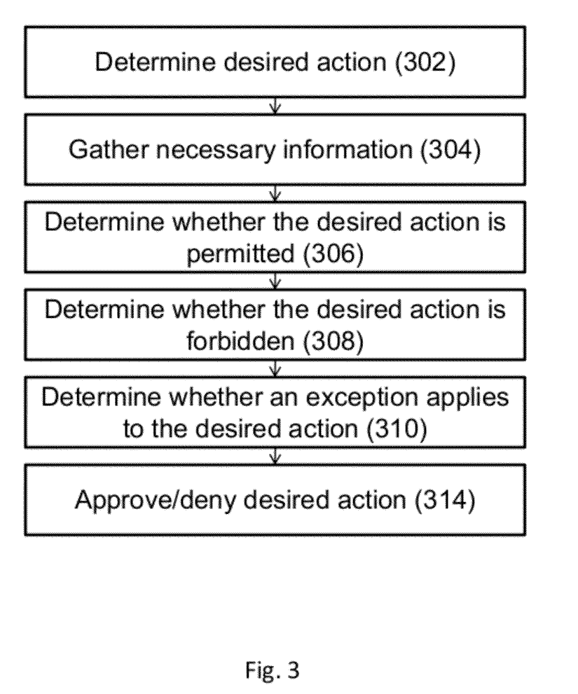

Shown in FIG. 3 is method for checking compliance with a law such as HIPAA laws according to an embodiment of the invention. Although the method is described in conjunction with the various system representations set forth herein, persons skilled in the art will understand that any system that describes the method steps, in any order, falls within the scope of the present invention.

As shown at step 302, a desired action is determined. In an embodiment of the invention described further below, the desired action is sending a message that is subject to laws or rules, but other actions can also be processed according to the teachings of the present invention. For example, any action for which there exist certain structured rules is appropriate for implementation according to the teachings of the present invention.

At step 304, necessary information is then gathered so that determinations can be made as to whether the desired action is to be allowed or forbidden. In an embodiment for a messaging system as described further below, the information collected at step 304 includes To (e.g., to whom a message is addressed), From (e.g., from whom a message is sent), About (e.g., about what is the message), Type (e.g., type of message), Purpose (e.g., purpose of the message), In Reply To (e.g., information about whether the present message is in reply to another message), Consented By (e.g., the person who consented to the message), and Belief (e.g., information about whether the sender has a belief about the subject message).

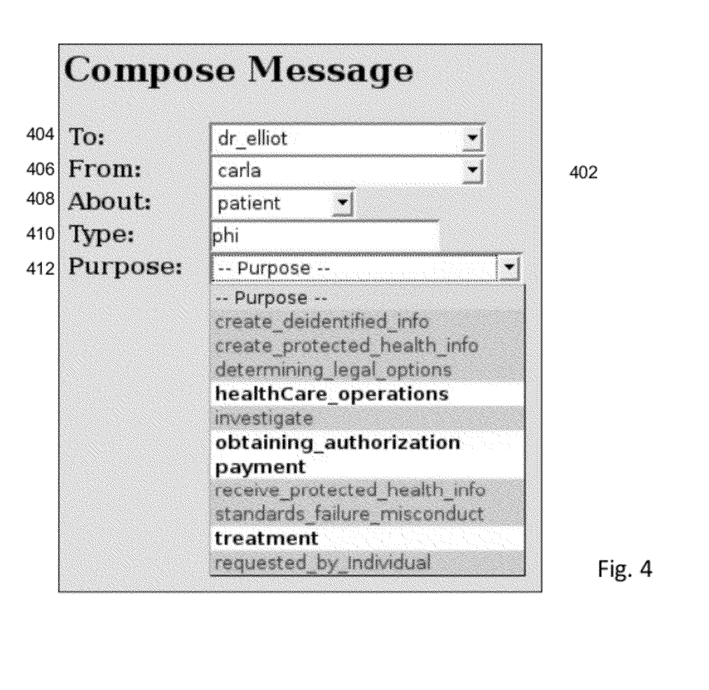

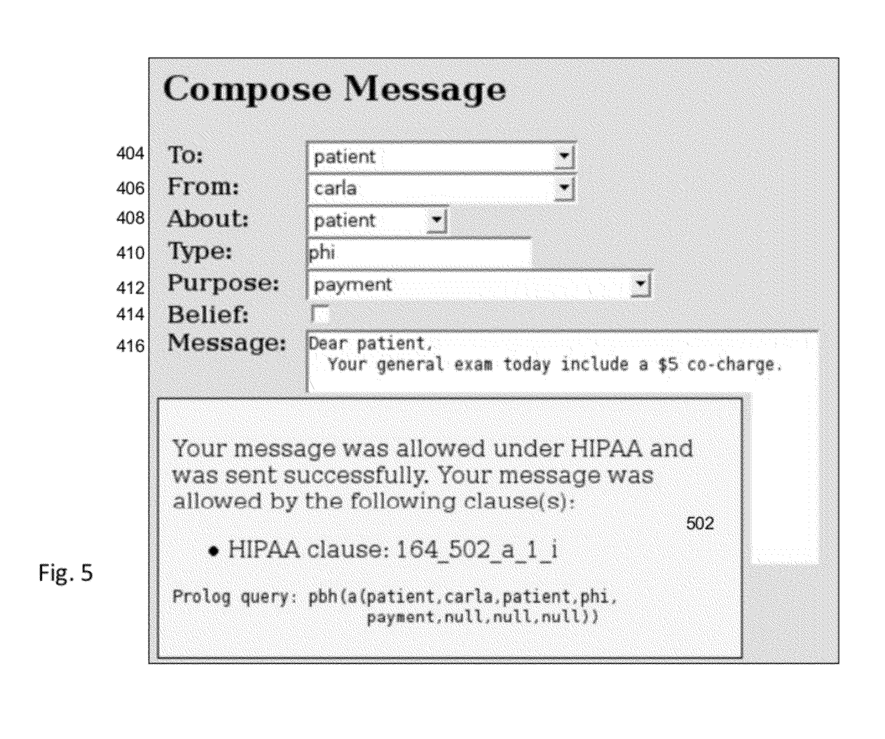

Shown in FIG. 4 are certain aspects of a graphical user interface (GUI) as may be implemented in accordance with the teachings of the present invention. As shown, screen 402 provides an interface by which the contents of a desired message may be entered. This screen seeks to provide a straightforward for inputting the broad range of patient messages. Shown in FIG. 4 is to field 404, From field 406, About field 408, Type field 410, and Purpose field 412. Also show in FIG. 4 is drop down menu 420 for Purpose field 412. Drop down menus can also be implemented for the other fields of the present invention. Other input techniques are likewise possible in other embodiments of the present invention. Further shown in FIG. 5 are Belief field 414, and Message field 416. It should be noted that fields 414 and 416 as well as other fields can also be included in screen 402 of FIG. 4.

According to an embodiment of the invention to be described further below, the To and From fields indicate the recipient and sender of the message. The About field identifies whose personal health information is contained in the message. The Type field defines, for example, the type of healthcare information mentioned in the message. Further examples include blood tests, X-ray results, or psychotherapy notes.

The Purpose field indicates a reason the message is being sent, such as for medical treatment. When the purpose is needed to determine compliance, the present invention assumes that a professional has asserted a purpose, or an asserted purpose is in some way inferred and made available as input to the compliance module. In an embodiment, the present invention infers when a purpose is needed, and provides the sender with a pulldown menu indicating purposes that would allow the message to be sent.

The In Reply To field describes a disclosure where the message is sent as a response to some earlier message. The Consented By field indicates which people have consented to the message disclosure.

The Belief field contains a collection of assertions about the current situation, such as whether this is a medical emergency, or whether disclosure is (in the opinion of the sender) in the best interest of the health of the patient. Some beliefs may not be indisputable facts in the sense that another person may think differently. But a sender may assert a belief (e.g., from a pulldown menu) or the sender's belief may be established by some other means. In an embodiment, once a message is allowed based on a belief, this reason is recorded and made available to a subsequent audit.

Turning back to the method of FIG. 3, at step 306, a determination is made as to whether the desired action is permitted by certain of the applicable laws or rules. In an embodiment of the invention, a messaging system described further below determines whether a desired action is permitted by all the applicable laws or rules (e.g., HIPAA laws). It should be noted, however, that other laws or rules may have a structure where different approaches may be taken. For example, other embodiments may only require that a certain subset of laws or rules allow a particular action.

At step 308, a determination is made as to whether the desired action is forbidden by certain of the applicable laws or rules. In an embodiment of the invention, a messaging system described further below determines whether a desired action is forbidden by at least one of the applicable laws or rules (e.g., HIPAA laws). It should be noted, however, that other laws or rules may have a structure where different approaches may be taken. For example, other embodiments may allow a particular action a condition exists where one law or rule allows an action but another law or rule forbids the action. Other manners of addressing conflicts in laws and rules are discussed further below.

At step 310, a determination is made as to whether an exception applies to the desired action as set forth in the applicable laws or rules. In an embodiment of the invention, a messaging system described further below determines whether an exception applies to a desired action that, for example, takes precedence over the results of steps is forbidden by at least one of the applicable laws or rules (e.g., HIPAA laws). It should be noted, however, that other laws or rules may have a structure where different approaches may be taken. For example, other embodiments may allow a particular action a condition exists where one law or rule allows an action but another law or rule forbids the action. Other manners of addressing conflicts in laws and rules are discussed further below.

In an embodiment, patients or professionals enter a message into a centralized message system as shown in screen 402 of FIG. 4. In this embodiment, the centralized message system can deliver the message by making it visible to other users. Messages may be simple questions from a patient, or may contain lab test results or other forms of protected medical information. Given information about the message, and other information such as the roles of the sender and receiver in the hospital, the HIPAA compliance module of the present invention decides whether delivery of the message complies with HIPAA. Thus, upon entering the appropriate information at screen 402, a user may be presented with screen 502 that, after execution certain methods of the present invention, notifies the user that the message was in compliance with HIPAA regulations and was sent. Screen 602, however, is presented if, after execution of certain methods of the present invention, a message is either forbidden or not permitted by HIPAA regulations and the message is not sent.

A structure of the present invention that provides for the formalization of laws, rules, regulations, and policies such as contained in HIPAA will now be described. Among other things, this embodiment of the present invention is designed to make compliance decisions based on eight message characteristics: To, From, About, Type, Purpose, In Reply To, Consented By and Belief. One of ordinary skill in the art will, however, understand how the discussion below can be modified without deviating from the teachings of the present invention.

Action: For the purpose of determining compliance, a message action is represented as an eight-tuple a= [symbol] u_{src},u_{dst},u_{abt}, m_{typ}, mₚᵤᵣ, a_{reply}, c, b [symbol] , where (note that underlining indicates a set)

| | |
|---|---|
| u_{src}, u_{dst}, u_{abt} | ε U (the set of users or agents), |
| m_{typ} | ε T (the set of types of messages), |
| mₚᵤᵣ | ε P (the set of purposes), |
| a_{reply} | ε A (the set of actions), |
| C = <u_{by}, c_{type}> | ε C (the tuple of consents) with |
| u_{by} | ε U (the set of users) and |
| c_{typ} | ε CT (the set of consent types), |
| b = <u_{by}, U_{abt}, b_{f}> | ε B (the set of beliefs) with |
| u_{by}, u_{abt} | ε U (the set of users) and |
| b_{f} | ε BF (the set of beliefs). |

In this embodiment, a HIPAA policy is a function from actions to Booleans (true or false), indicating permission or prohibition.

U×U×U×T×P×A×C×B→{T,F}

Category: A category is a set of field values defining the conditions when a legal clause is applicable to a particular action. For example, one common category of actions is those with type indicating protected health information and purpose indicating medical treatment.

Subcategories: Some field values may indicate that the action belongs to a subcategory of another category of actions. For example “psychotherapy note” is a subtype of “health records,” which implies that policy about health records could also affect decisions about psychotherapy note, but not vice versa. More generally, the possible values associated with any field may be partially ordered.

Roles: While it is possible to express policy about specific individuals, HIPAA policies are written using roles. For example, an individual could be a nurse or a doctor. When an action is considered, the system of the present invention receives the names of the sender and recipient, for example, and then uses information about the hospital to determine the respective role(s). For patients, similar processing (formalized in Prolog) is used to determine whether the patient is an adult or a minor.

Further concepts for the formalization of HIPAA are introduced using 164.508.a.2 of HIPAA as a running example. As stated above, 164.508 as a whole governs uses and disclosures of protected health information that require an authorization. Specifically, 164.508.a.2 states, among other things, that a covered entity must obtain an authorization for any use or disclosure of psychotherapy note, except if it is to be used by the originator of the psychotherapy note for treatment.

Requirement: An action that falls into the category of a legal clause is allowed only if the requirement in the clause is satisfied. For example, 164.508.a.2 states that the specified action is allowed only if an authorization is obtained.

Exception: An exception in a legal clause qualifies its category. For example, 164.508.a.2 states that if the purpose of the action is for use by the originator of the psychotherapy note for treatment, then the requirement does not apply.

Clause vs. Rule: For ease of exposition, a labeled paragraph in the HIPAA law is called a clause, and its translation into logic rules.

To illustrate this terminology, a clause with category given by predicate a, requirement predicate c and exceptions e can be expressed as the following rules:

permitted_by_{R} [symbol] (a [symbol] e) [symbol] c

forbiddent)by_{R} [symbol] (a [symbol] e) [symbol] c

R_not_applicable [symbol] a [symbol] e

Combination: A central concept in the approach of the present invention is the manner in which a policy composed of several legal clauses is expressed by a combination of the associated permitted_by and forbidden_by rules. Given rules R1 . . . Rm, any action is consistent with the policy of these rules if it is permitted by at least one of the rules and not forbidden by any of them.

compliant_with_{R1 . . . Rm} [symbol] (permitted_by_{R1} [symbol] . . . permitted_by_{Rm}) [symbol] (forbiddent_by_{R1} [symbol] . . . forbiddent_by_{Rm})

This approach allows each clause to be translated into rules that are then combined in a systematic way to express the requirements of the law.

Cross-Reference: Frequently a requirement of a clause involves a reference to other clauses of the law. In the formal definition discussed below, the present invention requires an acyclicity condition so that the cross-reference relation among HIPAA clauses forms a directed acyclic graph.

A fragment of stratified Datalog is identified with one alternation of negation, which is referred to for simplicity as pLogic, which suits the present formalization approach and supports a certain degree of policy compositionality. It is designed so that, given an action, the present invention can verify whether the action is compliant with the written policy.

The method of the present invention for translating HIPAA into stratified Datalog with one alternation of negation is structured according to the form of pLogic rules and pLogic policies given below. As is standard in logic programming, a predicate is a symbol with an associated arity. Because the present invention uses only Datalog, a term is a variable (starting with an upper-case letter) or an object constant (starting with a lower-case letter). An atom is an n-ary predicate applied to n terms. A literal is an atom. An expression is ground if it contains no variables.

Intuitively, a pLogic rule is a translation of a HIPAA clause into permitted and forbidden conditions. Each rule R therefore gives conditions on predicates permitted_by_{R} or forbidden_by_{R}, taking actions as arguments, indicating whether the action should be allowed or denied. pLogic facts may be used to define subsidiary predicates or other inputs to the compliance process.

pLogic Facts: A pLogic fact is an atom gi(a1, . . . , an) written using any relation gi of arity n.

pLogic Rule: The pLogic rules associated with a HIPAA clause Ri possibly cross-referencing clauses Rj, . . . , Rk have the form:

permitted_by_{Ri}(A) [symbol] category_{—}Ri(A) [symbol] exception_{—}Ri(A) [symbol] requirement_{—}Ri(A) [symbol] (permitted_by_{Rj}(A) op_{i,j+1} . . . op_{i,k} permitted_by_{Rk}(A))

forbidden_by_{Ri}(A) [symbol] category_{—}Ri(A) [symbol] exception_{—}Ri(A) [symbol] (requirement_{—}Ri(A) [symbol] forbiddent_by_{Rj}(A) [symbol] . . . [symbol] forbidden_by_{Rk}(A))

where
permitted_by_{Ri}, forbidden_by_{Ri}, category_Rᵢ, exception_Rᵢ and requirement_Rᵢ are predicates on actions,
each op_{i,x} is either the [symbol] (AND) or the [symbol] (OR) operator, as specified in the corresponding legal clause in HIPAA,
category_Ri, exception_Ri and requirement_Ri may appear as the head of additional Datalog rules considered to be part of the rule expressing the clause,
Every variable in the body must appear in the head,
As indicated, permitted_by_{Ri} may depend on permitted_by_{Rj} for another clause Rⱼ, but not forbidden_by_{Rj}, and similarly forbidden_by_{Ri} may depend on another forbidden_by_{Rj} but not permitted_by_{Rj}.

In the definition given above, the requirements are considered to be both may and must. However, the definition could easily be generalized to put one requirement in the permit rule and another in the forbid rule.

pLogic Policy: An pLogic policy is a set Δ of pLogic rules and pLogic facts whose dependency graph (defined below) is acyclic.

The dependency graph [symbol] V, E [symbol] of [symbol] [symbol] Δ is defined as follows. The vertices V are predicates occurring in Δ and E contains a directed edge from u to v exactly when there is a rule in Δ where the predicate in the head is u and the predicate v appears in the body. The acyclicity condition ensures a nonrecursive stratified Datalog program.

Entailment for pLogic is based on the usual stratified semantics from deductive databases and logic programming. pLogic policy is decidable pLogic policy is a nonrecursive logic program with negation and without function constants. Restricting the arity of the predicates to a constant reduces the complexity to polynomial time.

pLogic is designed so that prohibition takes precedence over permission. But care must be taken in translating HIPAA into pLogic when it comes to overlapping clauses. Two rules are said overlap if the category and exceptions of the two rules allow them to apply to the same action, and one is a subcase of the other if its category and exception make it apply to every action satisfying the category and exceptions of the other. Two overlapping rules conflict if one permits an action while another forbids it; two rules are disjoint if there exists no action to which both apply.

Some example relationships between rules are illustrated in Table 1. All three rules presented in the table are pairwise overlapping. But only rule R₅₀₂ₐ₁ᵢᵢ has a category that is a subcategory of another, specifically rule 502a1v.

| | | Category | | | Requirement | |
|---|---|---|---|---|---|---|
| | | A_{from} | A_{type} | Aₚᵤᵣₚₒₛₑ | A_{consent} | |
| R₅₀₂ₐ₁ᵢᵢ | + | covered entity | health records | treatment | * | permitted_byR506(A) |
| | − | covered entity | health records | treatment | * | forbidden_byR506(A) |
| R₅₀₂ₐ₁ᵥ | + | covered entity | health records | * | * | permitted_byR506(A) |
| | − | covered entity | health records | * | * | forbidden_byR506(A) |
| R₅₀₈ | + | * | psy-therapy note | * | <x, authz> | |
| | − | * | psy-therapy note | * | <x, authz> | |

### Table 1

### Examples of Overlapping Rules in HIPAA

Based on experience with HIPAA, when two rules are disjoint or overlapping, but neither is a subcase of the other, the general approach of the present invention provides the correct results: an action is permitted if it is permitted by at least one rule and not forbidden by any. When one clause addresses a subcase of another, it often appears to be the expressed intent of the law to have the more specific clause take precedence over the other clause. In other words, it appears correct to disregard both the permitted and forbidden conditions of the less specific clause, and use only the more specific clause. The present invention can handle this correctly within pLogic, by using exceptions to narrow the scope of the less specific rule so that it is not applied in the conflicting subcase.

Generally, disregarding the added complexity of cross-references and exceptions, conflicts happen when the category of an action matches two or more rules, the requirement for one rule is satisfied and the requirement for the other is violated. In the above example, an action like

[symbol] from: covered entity, type: health records, for: treatment, requirement: —as satisfying R₅₀₆

[symbol]

is permitted by R₅₀₂ₐ₁ᵢᵢ but forbidden by R₅₀₂ₐ₁ᵥ. Because this embodiment of the invention is designed to give precedence to parts of the law that forbid an action, an action that is permitted by one of two overlapping rules and forbidden by the other will be considered forbidden. Of course, other prioritizations of laws and rules may generate different results.

In cases where one rule specifies a category that is a proper subset of the category of another rule, giving precedence to denial may be incorrect because the more specific clause of the law was intended to have higher priority. A way to modify the translation of the law into rules is to add exceptions to the more generic rule to make the two rules disjoint. In the example illustrated above (in the table), an exception to rule R₅₀₂ₐ₁ᵢᵢ is added specifying for: [symbol] treatment. This causes rule R₅₀₂ₐ₁ᵢᵢ not to be applied when the purpose is treatment, eliminating the problematic conflict. Another solution is to assign priorities and split all the overlapping rules to make them disjoint. If applied throughout, the alternative approach could produce a more efficient compliance checker, but requires substantial effort to properly split all rules because many HIPAA rules are overlapping.

Additionally, the approach of the present invention has the advantage that it better preserves the correspondence between the logic rules and the corresponding legal clauses. To elucidate the structure of HIPAA and its translation in logic an example is provided in the appendix.

Other embodiments of the present invention involve audit, implicit information, and obligations. As mentioned above in connection with beliefs asserted by the sender of a message, compliance decisions depend on the accuracy of the information provided by the users. Users of a hospital medical system are generally professional practitioners who will provide correct information. But there may be some instances in which faulty or questionable information is entered. To provide accountability, auditing systems can be added to provide trace logs of how decisions are made and when beliefs or other potentially questionable input is used.

Another embodiment of the present invention can infer relevant information to reduce the amount of information the user has to provide to send a message. This can be achieved by extracting information from the message itself or by reasoning about the context of an action and information in previous messages among other things.

Since obligations to perform future actions arise in many privacy contexts, the approach of the present invention can be applied to support broader obligations. While the present invention represents the past explicitly through the in-reply-to field of messages, which produces linked structures of relevant past actions, future obligations may require an additional approach. But Although Prolog and Datalog do not have a concept of past or future, one method of providing a chronology can be to periodically run a scheduled process which scans the log and checks whether, for any particular action, any further action is required. The concerned person can then be notified.

An example for encoding a law such as HIPAA will now be provided. The teachings of the present example, can be extended to other HIPAA laws. Indeed, the present teachings can be extended to many other applications.

In this example, a part of clause R164.502 is considered which states that a covered entity can give out health records if it adheres to R_{502b} or R₅₀₆ₐ₂ and satisfies additional conditions:

164.502.b Standard: Minimum necessary
164.502.b.1 Minimum necessary applies.
   When using or disclosing protected health information or when requesting protected health information from another covered entity, a covered entity must make reasonable efforts to limit protected health information to the minimum necessary to accomplish the intended purpose of the use, disclosure or request.
164.502.b.2 Minimum necessary does not apply.
   This requirement does not apply to:
   (i) Disclosure to or requests by a health care provider for treatment;

In short, R_{502b} implies that when the covered entity is giving out the information to another covered entity, it should ensure that it is minimal information except for the purposes of treatment. Thus, the category for this clause is from: covered entity and to: covered entity and type: health records. The requirement is belief: minimal. The exception is for: treatment.

164.502 Uses and disclosures of protected health information.
164.502.a Standard. A covered entity may not use or disclose protected health information, except as permitted or required by this subpart or by subpart C of part 160 of this subchapter.
   164.502.a.1 Permitted uses and disclosures. A covered entity is permitted to use or disclose protected health information as follows:
      (ii) For treatment, payment, or health care operations, as permitted by and in compliance with 164.506;

The clause R₅₀₂ₐᵢᵢ implies that when a covered entity is sending health records for the purposes of treatment then it should also comply with R₅₀₆. Here the category is from: covered entity and type: health records and purpose: treatment. The requirement is to comply with R₅₀₆.

Thus the logic translation of the two clauses is:

Rules:—

```
permitted_by_{502b}(A) [symbol]
  (A_{from} = covered entity) [symbol]   (A_{type}=health records) [symbol]   (Aₜₒ=covered entity) [symbol]
  (Aₚᵤᵣₚₒₛₑ=treatment) [symbol]   (A_{belief}=minimal)
forbidden_by_{R502b}(A) [symbol]
  (A_{from}=covered entity) [symbol]   (A_{type}=health records) [symbol]   (Aₜₒ=covered entity) [symbol]
  (Aₚᵤᵣₚₒₛₑ=treatment) [symbol]   (A_{belief}=minimal)
permitted_by_{R502aii}(A) [symbol]
  (A_{from}=covered entity) [symbol]   (A_{type}=health records) [symbol]   (Aₚᵤᵣₚₒₛₑ=treatment) [symbol]
  forbidden_by_{R506}(A)
```

Policy:—

```
compliant_with_{HIPAA} [symbol]
  permitted_by_{502b} [symbol]    permitted_by_{R502aii} [symbol]    (forbidden_by_{R502b} [symbol]
  forbidden_by_{R502aii})
```

Attributes:—

Attributes and relations are defined. Consider a relation called in Role that identifies a particular individual and their role. Consider the example where dr_cox, a doctor, and carla, a nurse, work at a hospital, Sacred Heart.

inRole(Carla, nurse)
inRole(dr_cox, doctor)
inRole(doctor, covered entity)
inRole(nurse, covered entity)
inRole(sacredHeart, covered entity)
employeeOf(sacredHeart, dr_cox)
employeeOf(sacredHeart, dr_cox)

A transitive closure of these rules is also possible which would imply that carla and dr_cox are a covered entity.

Given this policy and the list of attributes, assuming dr_cox and carla work for the same hospital and R₅₀₆ is satisfied, an action that would be allowed with this particular rule system is:

(from: carla, to: dr_cox, type: health records, for: treatment)

The policy would permit this action because of the rule R₅₀₂ₐᵢᵢ An action like

(from: carla, to: xyz, type: health records, for: treatment)

would not be allowed as there is no relation stating that xyz is some kind of covered entity and there is no other rule in the policy permitting this action.

It should be appreciated by those skilled in the art that the specific embodiments disclosed above may be readily utilized as a basis for modifying or designing other techniques for carrying out the same purposes of the present invention. It should also be appreciated by those skilled in the art that such modifications do not depart from the scope of the invention as set forth in the appended claims.

We claim:

1. A method for checking compliance with a set of rules, comprising:
identifying a desired action to be taken;
collecting a first set of information;
determining whether the desired action is permitted by the set of rules based on the first set of information;
determining whether the desired action is forbidden by at least one of the rules within the set of rules based on the first set of information;
permitting the desired action if the determination is made that the desired action is permitted and if the determination is made that the desired action is not forbidden.

2. The method of claim 1, further comprising determining whether the set of rules are applicable to the desired action.

3. The method of claim 1, wherein the desired action is sending a message to at least one recipient.

4. The method of claim 3, wherein the first set of information includes information regarding to whom the message is sent, from whom the message is sent, and about what the message is.

5. The method of claim 3, wherein the first set of information includes information regarding a type of message.

6. The method of claim 3, wherein the first set of information includes information regarding a belief regarding the message.

7. The method of claim 3, wherein the first set of information includes textual information.

8. The method of claim 1, further comprising resolving a conflict between whether the desired action is forbidden and whether the desired action is permitted.

9. The method of claim 1, further comprising determining whether at least one exception applies to the desired action based on the first set of information.

10. The method of claim 9, further comprising resolving a conflict among whether the desired action is forbidden, whether the desired action is permitted, and whether an exception applies to the desired action.

11. A computer-readable medium including instructions that, when executed by a processing unit, cause the processing unit to check for compliance with a set of rules, by performing the steps of:
identifying a desired action to be taken;
collecting a first set of information;
determining whether the desired action is permitted by the set of rules based on the first set of information;
determining whether the desired action is forbidden by at least one of the rules within the set of rules based on the first set of information;
permitting the desired action if the determination is made that the desired action is permitted and if the determination is made that the desired action is not forbidden.

12. The computer-readable medium of claim 11, further comprising determining whether the set of rules are applicable to the desired action.

13. The computer-readable medium of claim 11, wherein the desired action is sending a message to at least one recipient.

14. The computer-readable medium of claim 13, wherein the first set of information includes information regarding to whom the message is sent, from whom the message is sent, and about what the message is.

15. The computer-readable medium of claim 13, wherein the first set of information includes information regarding a type of message.

16. The computer-readable medium of claim 13, wherein the first set of information includes information regarding a belief regarding the message.

17. The computer-readable medium of claim 13, wherein the first set of information includes textual information.

18. The computer-readable medium of claim 11, further comprising resolving a conflict between whether the desired action is forbidden and whether the desired action is permitted.

19. The computer-readable medium of claim 11, further comprising determining whether at least one exception applies to the desired action based on the first set of information.

20. The computer-readable medium of claim 19, further comprising resolving a conflict among whether the desired action is forbidden, whether the desired action is permitted, and whether an exception applies to the desired action.

21. A computing device comprising:
a data bus;
a memory unit coupled to the data bus;
a processing unit coupled to the data bus and configured to
identify a desired action to be taken;
collect a first set of information;
determine whether the desired action is permitted by the set of rules based on the first set of information;
determine whether the desired action is forbidden by at least one of the rules within the set of rules based on the first set of information;
permit the desired action if the determination is made that the desired action is permitted and if the determination is made that the desired action is not forbidden.

22. The computing device of claim 19, wherein the memory includes instructions that, when executed by the processing unit, cause the processing unit to perform the identifying, collecting, determining, and permitting steps.
